(19) United States
(12) Patent Application Publication
(10) Pub. No.: US 2010/0257051 A1
(43) Pub. Date: Oct. 7, 2010

(54) APPARATUS AND METHODS FOR THE ON-LINE DISTRIBUTION OF DIGITAL FILES

(75) Inventor: Álvaro Fernández Gutiérrez, Barcelona (ES)

Correspondence Address: BERENBAUM WEINSHIENK PC, 370 17TH STREET, SUITE 4800, DENVER, CO, 80202, US

(73) Assignee: MEDIA PATENTS, S.L., Barcelona (ES)

(21) Appl. No.: 12/761,273

(22) Filed: Apr. 15, 2010

Related U.S. Application Data
(63) Continuation of application No. PCT/EP2008/009616, filed on Nov. 13, 2008.

(30) Foreign Application Priority Data
Nov. 23, 2007 (ES) P200703089

(51) Int. Cl. G06Q 30/00; G06F 15/16; G06Q 10/00

(52) U.S. Cl. 705/14.43; 709/217; 705/14.41

(57) ABSTRACT

Processes for the on-line distribution of digital files with advertisements, advertisement management systems, digital rights management systems, and a user computing devices are provided. In some implementations, a computer-implemented method involves establishing communication between a first site and a user computing device by use of a link on a referring site and receiving in the first site referring site information that identifies the referring site. The link of the referring site being associated with a digital file stored on the first site, or otherwise made available through the first site, is transmitted in its entirety, or in part, to the user computing device along with one or more associated advertisements upon the first site receiving a request originating from the computing device to download all or a portion of the digital file to the computing device. In some implementations, upon detecting that the one or more advertisements have been played in the user computing device the first site generates or otherwise maintains information useable to remunerate the referring site. In some implementations the process of transmitting at least a portion of the digital file and the one or more associated advertisements to the user computing device involves first creating an updated digital file by combining the one or more advertisements with at least a portion of the digital file.

### CROSS-REFERENCE TO RELATED APPLICATIONS

This application relates to and claims priority to PCT Application No. PCT/EP2008/009616, filed Nov. 13, 2008, which relates to and claims priority to Spanish Patent Application No. P200703089, filed Nov. 23, 2007.

### FIELD

The invention relates to processes for the on-line distribution of digital files and advertisements. The invention is primarily though not exclusively applied to audiovisual contents with intellectual property rights. In the sense of the present invention, audiovisual content with intellectual property rights is understood as a set of data in one or several digital files which can be played in an audiovisual player and the use of which is protected by intellectual property rights.

### BACKGROUND

The trend offered today on the market for playing audiovisual content with intellectual property rights, such as movies or music for example, is aimed at developing a series of Digital Rights Management or DRM technologies such that users pay for viewing the contents of greater interest without receiving advertising in the contents. The so-called VOD (Video On Demand), virtual stores which sell the content on the Internet, and also IP payment or PPV (Pay Per View) televisions in which a user pays to see certain content, are based on this principle.

Content producers and distributors using this payment per content principle have been very negatively affected with the creation of P2P (Peer_to_Peer) networks, which allow exchanging files with content free of charge without the user who sees the content paying any price at all. There are a number of P2P networks, such as eMule, Ares Galaxy or BitTorrent for example, which have become very wide-spread. P2P transmissions are systems using the upload bandwidth of each user receiving a file for sharing the file. Thanks to this upload bandwidth, each user receiving data of a file sends to other users these same data. A network of users exchanging data forming the file with one another, instead of each user downloading the entire file from a provider site, is thus formed.

The owners of the intellectual property rights of the files distributed in P2P networks have initiated a number of legal actions in different countries with the intention to shut down the P2P networks. To prevent the shut-down of the servers managing P2P networks by the police or other official or judicial organisms, P2P networks have evolved in two ways: on a technological way and on a legal way.

From a technological point of view, “pure” P2P networks have emerged in which there are no servers that can be shut down by means of a judicial or police action. These new networks use new technologies, such as DHT or Distributed Hash Tables for example, which allow networks to operate without a server, whereby there is not a single central point where the police can stop the operation of the network. In order to stop a pure P2P network it is necessary to paralyze all its nodes or most of them, which greatly hinders the effectiveness of legal actions aimed at shutting down these networks.

From the legal point of view, new P2P networks have emerged such as Bit Torrent, the servers of which contain no file with intellectual property rights, rather they only contain “bit torrent” files with information on the points of the P2P network from which parts of a file with intellectual property rights can be downloaded, and it is debatable that the supply of a simple bit torrent file is illegal.

The discussion regarding the legality of P2P networks must further take into account legal uses of the networks, such as downloading files the owners of which have agreed to the download: demo software versions, open code software, content under the Creative Commons license and the like. For these reasons the current legal status of P2P networks is not altogether clear and furthermore changes depending on the country.

In opposition to this pay per content system which, as previously mentioned, has been very negatively affected by the emergence of P2P technologies, is the conventional television which broadcasts unrestrictedly and in which the users do not have to pay to see the content. Conventional television applies an advertising system in which the television channel offers advertisers a space that is reserved on its broadcasts to insert advertisements, and the cost of each advertisement depends on the duration thereof and on the expected audience for the time it will be broadcast. In addition, predictions relating to the type of audience, i.e. to the profile of the expected spectator, allow adjusting the type of advertisement for each channel and time slot. This same advertising system is currently used in digital cable television, with the difference that by having a large number of thematic channels, it is possible to more accurately predict the profile of the typical spectator of each channel.

The broad diffusion of the Internet network and the emergence of P2P networks have not significantly affected this conventional television advertising system, which continues to operate without suffering the income losses that are affecting the sale of music and movies in CD and DVD formats. It therefore seems that there is a rather widespread and accepted social behavior consisting of watching commercial television channels that insert advertising in their contents to finance the broadcasts and that this model is more widely accepted by users than the pay per content system.

Applying the principles of the conventional television advertising system to the field of Internet downloads, i.e. a user access audiovisual content in exchange for watching advertising, is of great interest. As previously mentioned, this system is more widely accepted socially than the pay per view system and allows suitably compensating the intellectual property rights owners.

However, in order for such a system applied to Internet downloads to work satisfactorily, technical solutions are necessary which allow on one hand reaching a large diffusion of the audiovisual contents offered by Internet and, on the other, allowing swift participation of the different participants: download sites, advertisers, users and intellectual property rights owners. Both conditions are necessary for such a system applied to Internet downloads to be sufficiently efficient and to be implemented in practice.

Companies advertising their products or services on the Internet attempt for their webpage to be found as easily as possible by a user navigating on network and interested in the products. A known method for attaining this objective consists of advertising the products on content webpages attracting users interested in a specific topic. These content webpages can be, for example, thematic pages on videogames, film, music, computer programs, etc. The advertisements are arranged in the form of advertising inserts including a link, such that when a user clicks on one of the links, he/she is redirected to the webpage of the selling company that has placed the advertisement and such company pays the content webpages a fee in accordance with the number of clicks made on the links.

U.S. Pat. No. 5,948,061 describes an application of this method in which the advertisers deliver to a server its advertisements in the form of advertising inserts so that it chooses which webpages are the most suitable for hosting each advertising insert. The webpages ascribed to this system contain a reference putting the browser of a user who visits the webpage in contact with the server, and then the latter sends to the browser an advertising insert, for example in the form of an advertising band or banner, for the browser to display it on the user's computer screen. Selection of the advertising insert sent to the browser is based on the information that the user's browser delivers to it, including an identification of the webpage that the user has visited and information about the user (such as the Internet address from which the browser acts and other data that the user has agreed to communicate). If the user clicks on the advertising insert, the browser again contacts the server and the server redirects it to a webpage of the advertiser.

A more evolved application of this method, which is more effective in relation to the way of organizing the relationship between the selling companies of products or services and the content webpages, and also in relation to the way of technically implementing the inclusion of advertising inserts in webpages and the fee for the clicks made, is the AdSense system of the Google search engine described in US Patent Applications published as US2004/0093327 and US2004/0059708. This system allows a website to include advertising of several advertisers and to receive a fee for it. The AdSense system analyzes the content of the webpages which are to host advertising inserts and decides which webpages are the most suitable for each advertising insert. The advertising inserts contain a link to the advertiser's webpage. Every time a user clicks on one of these advertising inserts, the owner of the webpage hosting the advertising insert obtains a fee from the advertiser. The AdSense system has the significant advantage of allowing companies to advertise on webpages the content of which is related to its products and which will therefore be the webpages visited the most by users who are potentially interested in the products. However, it has the drawback that it does not effectively allow preventing fraudulent clicks occurring when the owners click on their own webpage advertising inserts for the sole purpose of increasing the fee that will be paid by the advertiser. Another type of fraudulent clicks consists of a company dedicated to repeatedly clicking an another company's advertising insert with the sole purpose of quickly reaching the maximum budget established for the advertising insert and to thus cause the automatic deactivation thereof The problem with the fraudulent clicks very negatively affects both advertisers, who pay for useless clicks, and the owners of the webpages hosting the advertising inserts. In fact, many advertisers reject this system or are willing to pay very little for the advertising inserts. To solve this problem within the AdSense system, it would be necessary to detect the situations in which a click is repeated several times from a single IP address and to provide a process for deciding whether or not they are fraudulent clicks. For reasons that are obvious to a person skilled in the art, such a solution complicates the operation of the system.

Another drawback of the AdSense system is that it does not respond to the specific problems of downloading digital files with intellectual property rights.

U.S. Pat. No. 6,363,356 describes a system offering a solution that can be applied to the online distribution of software with the option of testing it before buying it. This system allows the advertiser to only pay for the clicks that have effectively resulted in a software sale. To that end, when a user clicks on an advertising insert and is redirected to the webpage of the software company, the URL (Uniform Resource Location) address of the webpage that hosted advertising insert is included in the redirectioning. This information is received and stored by the software company's webpage server and is added to the digital file when the user downloads it. Therefore, when the user contacts the software company's webpage again to buy a use license for the software, it is possible to know on which webpage the advertising insert that generated the purchase of the license was located.

This system disclosed in U.S. Pat. No. 6,363,356 has not been extended because it has several drawbacks. A first drawback consists of the fact that it is not designed to be applied globally: each advertising company must implement its own method to relate itself with content webpages and to include advertising inserts in them. A second drawback of this system is that in order to add the reference Web URL address to the downloaded file, the file is encapsulated in a wrapper and the information is added to the wrapper. The user does not directly download the digital file that he had selected, but rather the wrapper containing it. This requires performing a recompilation process before downloading and therefore a wait time is introduced that is too long for the standard download time scale on the Internet. This is the main reason that this system was never developed in practice. A third drawback of this system is that it does not provide for the case in which the download is direct, i.e. directly from a content webpage offering downloads, such as the webpage www.tucows.com for example.

As has been seen, the known technical solutions are not entirely satisfactory. For this reason, current audiovisual contents distribution systems only offer the option of paying to see the content, with the aforementioned consequence that many users choose to download the contents from the P2P networks, whereby the intellectual property rights owners receive no fee.

U.S. Pat. No. 7,152,091 discloses an advertising method applied to downloading contents on the Internet consisting of showing advertising in a user's browser while the user downloads a content. The download is cut off if the user interrupts the playing of advertising in the user's browser. This method has the drawback that it is rather ineffective in practice because users are not used to being in front of a computer during the time a download takes. With the currently available technology for most users, downloading a 400 Mbyte video takes approximately four hours, whereby it is common for a user to launch a download and to leave to do other things. In addition, the method described in U.S. Pat. No. 7,152,091 does not allow controlling that the user actually sees the advertisements. Even in the event that the user remains in front of the computer, he/she can reduce the browser window in which the advertisements are shown and continue doing other things in the computer.

### SUMMARY OF THE DISCLOSURE

A purpose of the invention is to provide improved systems for the on-line distribution of digital files, such as for example, those containing audiovisual content.

An object of the invention is to provide systems which allow carrying out a mass diffusion of audiovisual contents such that, as the case may be, a fee can appropriately be paid to the owners of the rights of the audiovisual contents.

Another object of the invention is to provide systems in which advertisers only pay for the advertisements which have been shown when the audiovisual contents associated to the advertisements have been played.

Another object of the invention is to provide systems which can generally be applied and automated without the companies that wish to advertise or the companies owning the rights of the audiovisual contents having to be preoccupied with contacting and negotiating with one another.

Another object of the invention is to provide systems which allow several parties to participate in the process from the first click made by a user who downloads a file with audiovisual content, until advertisements associated to the audiovisual content are shown and makes it possible to suitably and separately pay a fee to each of them.

Another object of the invention is to provide systems which do not negatively affect the speed of downloading the digital files and which do not complicate the process of playing the audiovisual contents of the digital files by a user.

Another object of the invention is to provide systems which are compatible with different P2P (peer-to-peer) type download technologies, such as the BitTorrent files transfer protocol for example.

For this purpose, in some implementations a process for the on-line distribution of audiovisual contents involves:

an intermediary site receives digital files with audiovisual content on-line and makes a selection of referring sites suitable for offering the digital files on-line;

advertiser sites provide the intermediary site with advertisements to be shown,

the intermediary site makes a selection of the advertisements and assigns to each digital file associated advertisements;

a user accesses one of the selected referring sites on-line, which offers the digital files on-line, and downloads one of the digital files on-line;

the downloaded digital file is used in equipment in which a user wishes to play the audiovisual content of the downloaded digital file;

the equipment receives the associated advertisements which have been assigned by the intermediary site to the downloaded digital file, and the associated advertisements are shown in the equipment;

it is checked that the associated advertisements have been shown in the equipment and after having performed the check:
[i] an audiovisual content player provided in the equipment plays the audiovisual content of the downloaded digital file, and
[ii] download identifying data, comprising at least identifying data of the referring site, and play information data, comprising at least information which allows identifying the associated advertisements, are transmitted on-line to the intermediary site;

based on the identifying data of the referring site, the intermediary site performs an action to remunerate the referring site and, based on the play information data, the intermediary site performs an action to receive remuneration from the advertiser sites that had provided the associated advertisements.

In accordance with some implementations, the invention provides a first advertisement management form in which the download identifying data is combined with the digital file before it is downloaded, i.e. before the download thereof is initiated or while it is being downloaded.

In some implementations the download identifying data is combined with the digital file as files properties metadata of the digital file.

In some implementations, the associated advertisements are incorporated within the digital file before it is downloaded, whereby the equipment receives the associated advertisements as part of the downloaded digital file.

In some implementations, an advertising management system cooperating with the player is executed in the equipment so that the associated advertisements, which are associated to the downloaded digital file, are shown by the player and to prevent playing the audiovisual content of the downloaded digital file in the player if the associated advertisements have not been shown in the player.

In some implementations, once the associated advertisements have been shown in the player, the advertising management system transmits on-line to the intermediary site the download identifying data, which are incorporated within or otherwise combined with the downloaded digital file, and the play information data.

In some implementations the advertising management system also transmits on-line to the intermediary site unique identifying data of the equipment or of the user of the equipment.

In some implementations the advertising management system communicates on-line with the intermediary site, transmits information to it which allows identifying the downloaded digital file and receives from the intermediary site new associated advertisements which were not incorporated in the downloaded digital file, and the advertising management system cooperates with the player so that it shows the new associated advertisements.

In some implementations the advertising management system communicates on-line with the intermediary site, transmits information to it which allows identifying the downloaded digital file and receives from the intermediary site indications to cancel associated advertisements which were incorporated in the downloaded digital file, and the advertising management system cooperates with the player so that the advertisements which have been cancelled by the intermediary site are not shown.

In some implementations the advertising management system cooperates with the player so that, when it has finished showing one of the associated advertisements the player waits to receive an indication from the user to begin to show the following associated advertisement. Furthermore, the advertising management system preferably cooperates with the player so that the latter does not show the audiovisual content of the downloaded file if the time elapsed between the moment in which the player has finished showing one of the associated advertisements and the moment in which the user indicates to the player to begin to show the following associated advertisement exceeds a certain threshold.

Advantageous solutions to more effectively carry out the distribution of digital files in which the intermediary site provides on-line to the referring sites links to be installed in the referring sites, such that when a user activates one of the links in one of the referring sites, the user is redirected to a download site to download, from the download site, the digital file; and the download identifying data, which are transmitted on-line to the intermediary site after having shown in the equipment the associated advertisements, comprise identifying data of the download site.

In some implementations a download management application is executed in the download site and receives the identifying data of the referring site and, when the user is redirected to the download site to download the digital file, the download management application incorporates within the digital file the identifying data of the referring site.

In some implementations the download management application which is executed in the download site incorporates within the digital file as the download data, in addition to the identifying data of the referring site, the identifying data of the download site.

According to some implementations other advertisement management forms, such as, for example, one in which in order to download the digital file, a browser of the equipment accessing a download site on-line is used; the download site sends the associated advertisements to the browser so that the browser shows them in the equipment and the download site does not allow the download of the file to be performed until the advertisements have been shown in the browser.

In some implementations the download site sends to the intermediary site on-line the download identifying data and the play information data.

In some implementations a digital rights management system, checking that the associated advertisements have been shown by the browser of the equipment and which cooperates with the player to prevent playing the audiovisual content of the downloaded digital file if the associated advertisements have not been shown in the browser, is executed in the equipment.

In some implementations the digital rights management system cooperates with the player to limit the number of times that the audiovisual content of the downloaded digital file can be played, and/or the time during which the audiovisual content can be played since the associated advertisements were shown in the browser.

In some implementations once one of the associated advertisements has been shown in the browser, the following associated advertisement is not shown in the browser as long as the user does not indicate, by interacting with the equipment, that the following associated advertisement should be shown.

In some implementations the download site does not authorize the download of the digital file if the time elapsed between the moment in which the browser has finished showing one of the associated advertisements and the moment in which the user interacts with the equipment to indicate that the following associated advertisement should be shown exceeds a certain threshold.

In some implementations the intermediary site makes an automatic selection of the advertisements provided by the advertiser sites and assigns them to each digital file. According to one implementation, the intermediary site receives on-line, together with the digital files, information about the audiovisual content category of each digital file, and the intermediary site is provided with an advertisement auction management module in which the different advertiser sites offer on-line a price for their advertisements for each audiovisual content category.

In particularly advantageous implementations that are especially applied to the on-line distribution of audiovisual contents with intellectual property rights, the intermediary site receives on-line the digital files from proprietary content sites and, after the audiovisual content of the downloaded digital file has been played in the equipment, the intermediary site receives on-line the play information data further comprising information which allows identifying the downloaded digital file, and the intermediary site performs an automatic action to remunerate the proprietary content site from which it had received the downloaded digital file.

Some implementations also relate to advertisement management systems and to the digital rights management systems, which have the functionalities described above in reference to the processes according to the invention. Some implementations also relate to an audiovisual content player incorporating any of these systems or methods.

### BRIEF DESCRIPTION OF THE DRAWINGS

Other advantages and features of the invention will be observed based on the following description in which some embodiments of the invention are described, with a non-limiting character, referring to the attached drawings.

FIG. 1 shows a block diagram illustrating an exemplary system for applying the processes according to some implementations of the present invention.

FIG. 2 shows a block diagram illustrating at a high level an algorithm executing a download application in a download site from which a file is downloaded after a link to the file has been activated in a referring site, according to a system of FIG. 1.

FIG. 3 shows a block diagram illustrating an algorithm executing an advertising management system in a user's equipment.

FIG. 4 shows a block diagram illustrating an algorithm executing an advertising management system in a user's equipment.

FIGS. 5 and 6 respectively illustrate the structure in one implementation of a file with audiovisual content which is downloaded by a user and the structure of an advertisement file which is transmitted by an intermediary site to update the advertisements which to be played together with the audiovisual content.

FIG. 7 shows a block diagram illustrating another exemplary system for applying the processes according to some implementations of the present invention.

### DETAILED DESCRIPTION

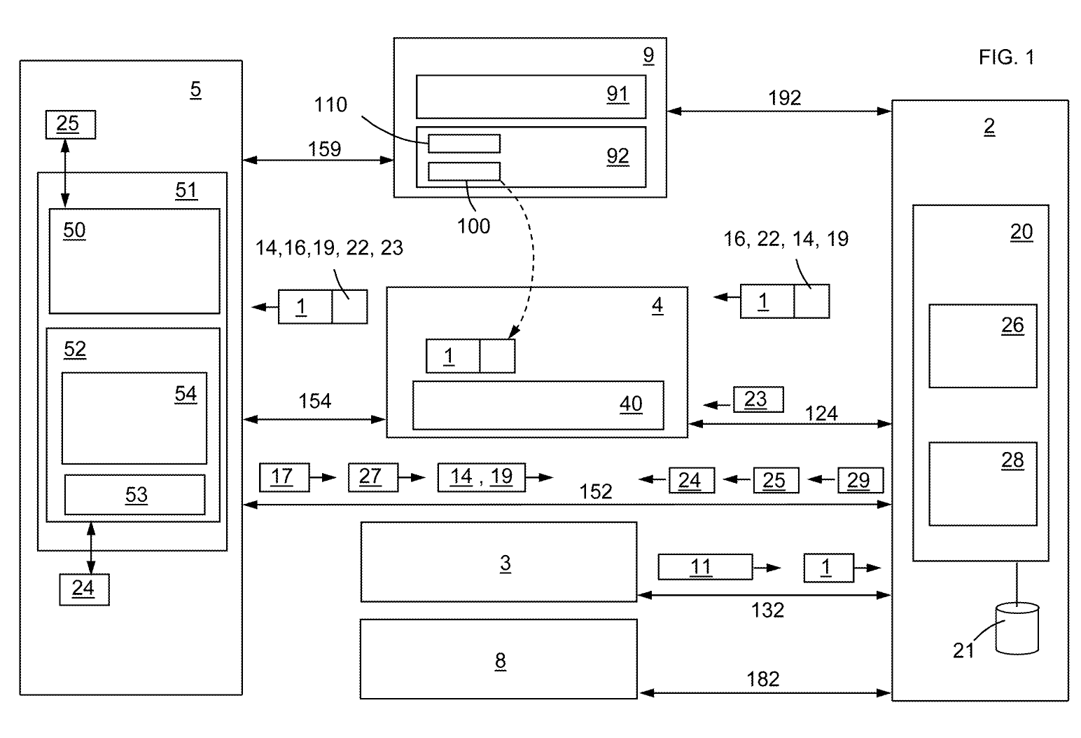

The block diagram of FIG. 1 schematically shows an exemplary system of applying processes according to the present invention. In this example, the data network is the Internet. The system is formed by a user's equipment 5, an intermediary site 2, a plurality of referring sites 9 associated to the intermediary site 2, a plurality of proprietary content sites 3, advertiser sites 8 and one or several download sites 4. In one implementation all these sites 2, 3, 4, 8 and 9 are Internet websites. For greater clarity in the explanation, a single referring site 9, a single proprietary content site 3, a single advertiser site 8 and a single download site 4 have been shown. However, the system and the process according to the invention are especially advantageous when a large number of referring sites 9 are involved because the greater the number of the referring sites 9 the greater the number will be of Internet users attracted by such sites and therefore the greater will be the number of file downloads.

In the different processes according to the invention, the different sites 2, 3, 4, 8, 9 and the user's equipment 5 can establish among one another the on-line communications shown in FIGS. 1: 152, 154, 159, 192, 132, 182 and 124.

The communications between the different sites of FIG. 1 can be carried out using different communication protocols or technologies such as FTP (File Transfer Protocol), HTTP (Hypertext Transfer Protocol), Web services, SOAP (Simple Object Access Protocol) objects, TCP/IP (Transmission Control Protocol/Internet Protocol) connections or any other method of communication between networks.

The example shown in FIG. 1 illustrates a case in which a digital file 1 containing, for example, music, video, images or text in digital format, which is protected by copyright and which can be played in a user's equipment 5, is downloaded. In this example, the equipment 5 is a computer with a connection to Internet. However, the invention can also be applied to other equipment that can be connected to a data network, such as mobile telephones or digital players with the capacity to connect to a data network for example. Returning to the example, the computer 5 has an operating system 51 in which a content player 52 capable of playing audiovisual content of a file 1 in a screen or window 54 is installed and which is equipped with an advertising management system 53.

The advertising management system 53 is a control system which in some implementations is capable of detecting that the audiovisual contents of the files 1 are protected by intellectual property rights and which sees to it that, along with playing the audiovisual content of each downloaded file 1, the advertisements associated thereto are shown. Some functionalities of an advertising management system 53 according to various implementations are described below.

The different steps of the processes according to example illustrated in FIG. 1, as well as the different logic elements and materials which allow applying the processes, are described below.

A proprietary content site 3 is a site of a company, or of a person, who owns or otherwise possesses the rights of audiovisual contents of files 1 and who is interested in obtaining advertising earnings derived from playing the audiovisual contents of the files 1.

The proprietary content site 3 is registered on-line 132 in the intermediary site 2. During this registration process 132, the proprietary content site 3 introduces its identifying data such as name, address, e-mail, etc., for example, and sends the files 1 to the intermediary site 2 so that the intermediary site 2 can distribute it. The intermediary site 2 has an intermediation application 20, for example with a Web interface, which allows performing the registration process and storing the registration information of the proprietary content site 3 in a database 21.

During the registration process, the proprietary content site 3 may also provide to the intermediary site 2 commercial information 11 related to the file 1. The commercial information includes information on the type of content which will allow the intermediary site 2 to select the most suitable advertising categories for each type of content, such as the name of the file, the name of the parties, the type of movie for example, etc. It may also include a series of key words associated to each file 1 indicating which is the content of the file and which will be used by the intermediary site 2 to select suitable referring sites 9 for each file 1, as will be seen below. The intermediary site 2 also stores this information 11 in the database 21, and can modify it so that it adapts to its own criteria, such as for example not advertising content for adults on Webs which are not classified as adult webs, or any other type of modification which the intermediary site 2 considers suitable to perform in the description of the files.

The intermediary site 2 preferably incorporates in each file 1 an identifier 16 which allows the intermediary site 2 to uniquely identify each file. Based on the identifier 1, the intermediary site 2 accesses its database 21 and consults the information associated to each file. For example, the identifier 16 can be a GUID (Globally Unique Identifier), which is a reference number randomly generated by the application and which in practice is unique because the probabilities that the same number is assigned twice are very small. GUID-based techniques are known by a person skilled in the art and it is therefore not considered necessary to explain them in greater detail.

The intermediary site 2 optionally incorporates directly in the files 1 advertisements 22 which must be shown when the audiovisual content of the files 1 is played. As will be seen below, it also provides that the download site 4 inserts advertisements 23 in the files 1, and that the intermediary site 2 directly sends advertisements 24 to the computer 5 in which the audiovisual content of the files 1 is played.

The intermediary site 2 reaches agreements with a series of referring sites 9 and download sites 4 which are interested in participating in the on-line distribution of files 1 in exchange for receiving a commission or percentage of the advertising earnings which are generated. As previously stated, FIG. 1 shows a single referring site 9 and a single download site 4 to facilitate the description. The function of the referring site 9 is to attract a certain group of users who are navigating on the Internet and who are interested in the content 91 offered by the referring site 9. The users who visit a webpage of the referring site 9 can see in the webpage advertising inserts 110 and download the files 1 by clicking on the respective links 100.

The intermediary site 2 makes a selection of the referring sites 9 which can advertise the different files 1. To that end, candidate sites to being referring sites 9 are communicated on-line 192 with the intermediary site 2 and perform an on-line registration process consisting of identifying (e.g., name, address, telephone, e-mail, etc.) and communicating the URL address which allows locating it on the Internet. During the registration process of the referring site 9, the intermediary site 2 can optionally request that a series of words or descriptions which are used to describe the content 91 of the referring site 9 are introduced.

In some implementations, when the referring site 9 finishes the registration process in the intermediary site 2, the intermediary site 2 supplies it with the code of an advertising insert and link management application 92 which the referring site 9 adds to its own webpage, for example by copying (Control+C in Microsoft® Windows) from the webpage of the intermediary site 2 the text of the code and pasting it (Control+V in Microsoft® Windows) in the HTML content of a webpage of the referring site 9. The advertising insert and link management application 92 can be, for example, a code in Javascript, PHP or ASP.NET language, which communicates with the intermediary site 2 by means of Web services (collection of protocols and standards used to exchange data between websites through the Internet). The advertising insert and link management application 92 also allows the intermediary site 2 to modify the advertising inserts 110 and the links 100 for the purpose of updating them. As will be seen below, this allows optimizing the efficacy of the referring sites 9 in terms of the number of file downloads and number of sales. The programming of the advertising insert and link management application 92 is within the scope of a person skilled in the art, as it forms part of the basic knowledge of any programmer who knows the operation of the Web services. It is therefore not considered necessary to explain them in further detail.

In some implementations, when the advertising insert and link management application 92 is executed in a webpage of the referring site 9, it shows the advertising inserts 110 together with the links 100. When a visitor of the webpage of the referring site 9 activates one of the links 100, the file 1 is downloaded in the visitor's computer 5.

In some implementations, once the referring site 9 has been registered, the intermediary site 2 analyzes the referring site 9 to check that the advertising insert and link management application 92 works properly and also to analyze the content 91 of the referring site 9. The intermediary site 2 counts the number of times that each word appears in the content 91 of the referring site 9, selects those words which in the referring site 9 are greater in number than certain percentage and stores this content information of the referring site 9 in its database 21. The intermediary site 2 then chooses the most suitable files 1 depending on the content 91 of the referring site 9. For example, a referring site related to black and white films will be especially suitable for downloading black and white movies, whereas a referring site related to rock music will be suitable for of rock music downloads. In order to choose which are the most suitable files 1 for each referring site 9, the intermediary site 2 compares the content information of the referring site 9 it has stored in its database 21 with the commercial information 11 of the files 1 provided by the proprietary content site 3, and chooses, for each referring site 9, the files 1 having a higher degree of coincidence with the content information of the referring site 9.

In order to optimize the number of file downloads 1 and its possible advertising earnings, the intermediary site 2 can vary the links 100 of each referring site 9 and perform a statistical follow-up of which generate more downloads and more advertising earnings. In some implementations the intermediary site 2 controls file downloads 1 in each referring site 9 and the advertising earnings generated by each file. This statistical information is stored in the database 21 of the intermediary site 2. The intermediary site 2 can thus establish which of the files 1 have the highest probability of being downloaded and played by relating the historical advertising earnings with the selected key words of each referring site 9. For example, by multiplying the advertising income created when the advertisements associated to the audiovisual content of the files 1 are shown by the commission percentage that the referring site 9 will earn, and taking into account the percentage of users who download a file and subsequently play the audiovisual content of the file 1 and see the associated advertisements, the intermediary site 2 obtains a statistical estimation of the earning that each click on a link 100 or each viewing of an advertisement of a file 1 involves for the referring site 9. The intermediary site 2 can thus update the advertising inserts 110 and the associated links 100 of a referring site 9 so that they advertise and indicate the files 1 which will generate greater earnings. Another method that the intermediary site 2 can use to select the most suitable files 1 for each referring site 9 consists of choosing files similar to the most successful files on another referring site 9 having a similar content 91. Evidently, a manual selection of the most suitable files 1, a manual selection being understood as a selection made by a person, is always possible, but at a high cost. This cost is preferably eliminated by using a computer program which automatically executes the described selection algorithms.

When a user uses the Internet browser 50 of the computer 5 to access a webpage of the referring site 9 containing the advertising insert and link management program 92 and activates one of the links 100, the process of downloading the file 1 associated to the link 100 is initiated from a download site 4. To that end, in some implementations each one of the links 100 contains a URL address pointing to the corresponding file 1 in the download site 4. This is schematically indicated in FIG. 1 by means of an arrow drawn with dotted lines indicating the file 1 from the link 100.

In some implementations the files 1 have previously been delivered to the download sites 4 by the intermediary site 2. In order to receive on-line 124 the files 1 provided by the intermediary site 2, the download sites 4 can use, for example, the FTP protocol. To that end, each download site 4 receives, for example, from the intermediary site 2 a user name and a password or access code authorizing him to receive files 1 from the intermediary site 2.

Preferably, as shown in the example of FIG. 1, the download sites 4 are different from the referring sites 9. This allows a user to download the files 1 from a download site 4 without the bandwidth or transmission speed of the communication of the referring sites 9 with Internet being affected by the file downloads and decreasing the access speed of the users who wish to see the content 91 of the referring sites 9. However, other set-ups of download sites 4 are possible without departing from the scope of the present invention. Therefore, for example, the download site 4 can be the actual referring site 9 if the latter has sufficient bandwidth to allow Internet users to consult its content 91 and at the same time download the files 1. Another possible set up is that the download site 4 forms part of the intermediary site 2.

In some implementations download identifying data 14, 19 are incorporated in the files 1 before the files 1 are downloaded by a user from a computer 5, or in the moment in which the download is initiated. The incorporation of this download identifying data in the files 1 can be done in different ways. An especially advantageous way of adding the data to the files 1 consists of including them as metadata of the files 1. This operation is carried out prior to the download or in the moment of the download, and can be carried out in the intermediary site 2 or partially in the intermediary site 2 and in each download site 4, as will be seen below.

The metadata of a file are data containing formal information of the file, such as for example the name, size, type of file, modification date, owner, etc. In Microsoft® Windows, these metadata can be seen in File>Properties of the Document menu in the graphic interface of the Windows applications. The location containing this metadata in the file has several fields which are currently free. In some implementations process these metadata-free fields for housing the download identifying data in them. Another solution according to the invention consists of defining new properties or metadata fields for a file, for example by using the Microsoft DSOFile.dll library, and housing the download identifying data in them.

In some implementations the download identifying data incorporated in the files 1 which are downloaded comprise at least identifying data 19 of the referring site 9 in which the user has activated the link 100 that led to the download. This identifying data 19, which includes for example the URL address of the referring site 9, allows identifying the referring site 9 to remunerate it for its participation in the event that an advertising income is generated, if the advertisements associated to playing the audiovisual content of the downloaded file 1 are shown.

Furthermore, the download identifying data also preferably comprise identifying data 14 of the download site 4 from which the file 1 is downloaded. This data 14, including for example the URL address of the download site 4, allow identifying the download site 4 to remunerate it for its participation in the event that an advertising income is generated, if the advertisements associated to playing the audiovisual content of the downloaded file 1 are shown.

In some implementations, before providing the files 1 to the download site 4, the intermediary site 2 incorporates to the files 1 all the download identifying data 14, 19 in the form of metadata of the files 1. The intermediary site 2 then delivers these files 1 to the download site 4 and also sends to the referring site 9 advertising inserts 110 in the form of text and/or images relating to the files 1 which have been sent to the download site 4, as well as the links 100 that the referring site 9 must publish on its webpage. When the advertising insert and link management program 92 of the referring site 9 receives the advertising inserts 110 and links 100, it shows them on the content webpage 91 in which it is installed. Any user accessing the referring site 9 through Internet will see the advertising inserts 110. When the user activates one of these links 100 in the referring site 9 it initiates from the download site 4 the download of the corresponding file 1, which will in some implementations incorporate the download identifying data 14, 19 in the form of metadata. This embodiment requires that the intermediary site 2 delivers to the download site 4 each one of the files 1 with all download identifying data incorporated, i.e. with the identifying data 14, 19. If, for example, there are 10,000 referring sites advertising a file 1 having a size of 50 Megabytes, the intermediary site must incorporate the download identifying data in 10,000 files and send each one of these files to the download site 4, which must store them all, thus taking up a space of 500 gigabytes.

In some implementations, the identifying data 19 of the referring site are incorporated in the files 1 in the moment of the download. To that end, when a user activates one of the links 100 in the referring site 9, the link 100 includes in some implementations a URL address to redirect to the download site 4 and it also includes in some implementations the actual URL address of the referring site 9 so that it can be transmitted to the download site 4. This can be done, for example, by passing the information of the URL address of the referring site 9 as a parameter in the URL address it takes from the webpage of the referring site 9 to the webpage of the download site 4. In some implementations in the download site 4 a download management application 40 receiving the identifying data 19 of the referring site 9 is executed and incorporates them as metadata to the file 1 to be downloaded by the user. An embodiment of this process is explained below.

A user accesses referring site 9 number 5,000 and activates link 100 to download the file 1. The link 100, which has been prepared by the intermediary site 2 and installed in the referring site 9 by the advertising insert and link management program 92, contains the following URL address:
http://www.download-site.com/referring-site-5000/f1.mp4

The first part “www.download-site.com” identifies the URL address of the download site 4, the second part “referring site-5000” is a parameter identifying the URL address of referring site number 5,000, and the last part f1.mp4 identifies the file 1 to be downloaded.

When the download site 4 receives the download request to download the file 1, the download management program 40 which is executed in the download site 4 examines this URL address, detects that it comes from referring site 9 number 5,000 and in some implementations adds the following information to the metadata of the file 1 as identifying data 19 of the referring site 9:
URL9=http://www.referring-site-5000.com
   wherein URL9 is a label which has been defined in the metadata of the file 1 by the intermediary site 2 to host the URL address of the referring site 9. The download management application 40 copies the URL address of the referring site 9 http://www.referring-site-5000.com in the URL9 label.

As a result of this preferred embodiment, the intermediary site 2 need only deliver to the download site 4 a single copy of each file 1 without needing to send a plurality of files 1 or to include in the download identifying data the identifying data 19 of the referring site 9. Returning to the numerical example explained above, it can be seen that by applying this preferred embodiment the intermediary site 2 sends to the download site 4 a single file with a size of 50 megabytes (instead of 10,000 files with a size total of 500 gigabytes).

When the download site 4 receives a visit that was redirected from a link 100 of a referring site 9, the download management application 40 of the referring site 4 in some implementations has different copies of the corresponding file 1 that was delivered by the intermediary site 2, and copies the identifying data 19 of the referring site 9 in the URL9 label of the metadata of one of the copies of the file 1. Once the data 19 has been introduced in the metadata of the copy of the file 1 the latter is downloaded in the user's computer 5.

The reason that the download management application 40 may have several copies of the files 1 that are downloaded prepared is that while one of the files is being downloaded, a process which can last several seconds or several minutes, the properties of the file cannot be modified so as to respond to a second download request which arrives before the file is fully sent to the first user who is downloading it. If the download management application 40 modifies the metadata of a file which is being downloaded to include the referring site for a second download before the first download ends, it is very likely that the first download will fail and a file with mistaken data will be downloaded.

If the size of the file 1 is small, the download management application 40 can make a copy in the very moment of the download request, modify the metadata of the copy and send the file with the updated metadata. If the size of the file is large, the download management application 40 would take several seconds or minutes to make a copy of the file to modify the metadata. This could involve a drawback similar to the one described at the beginning for the system of U.S. Pat. No. 6,363,356, which consists of recompiling the program to generate a wrapper (although in this case the drawback would be less because making a copy of a file is a much faster process than recompiling a program in a new file).

In any modern operating system, such as Microsoft Windows Server 2003 for example, moving a file from one directory to another in the same disc is a virtually instantaneous process which simply requires slightly modifying the directory structure. This process of moving a file is much faster than creating a copy of the file in the moment of the download.

It is therefore suitable for the download management application 40 to have several copies of the files 1 prepared beforehand, and it can adapt the number of copies of each particular file 1 according to the download statistics of the file. Making copies can be optimized by optionally using RAM memory based discs, in addition to having the mentioned already prepared copies ready to be sent.

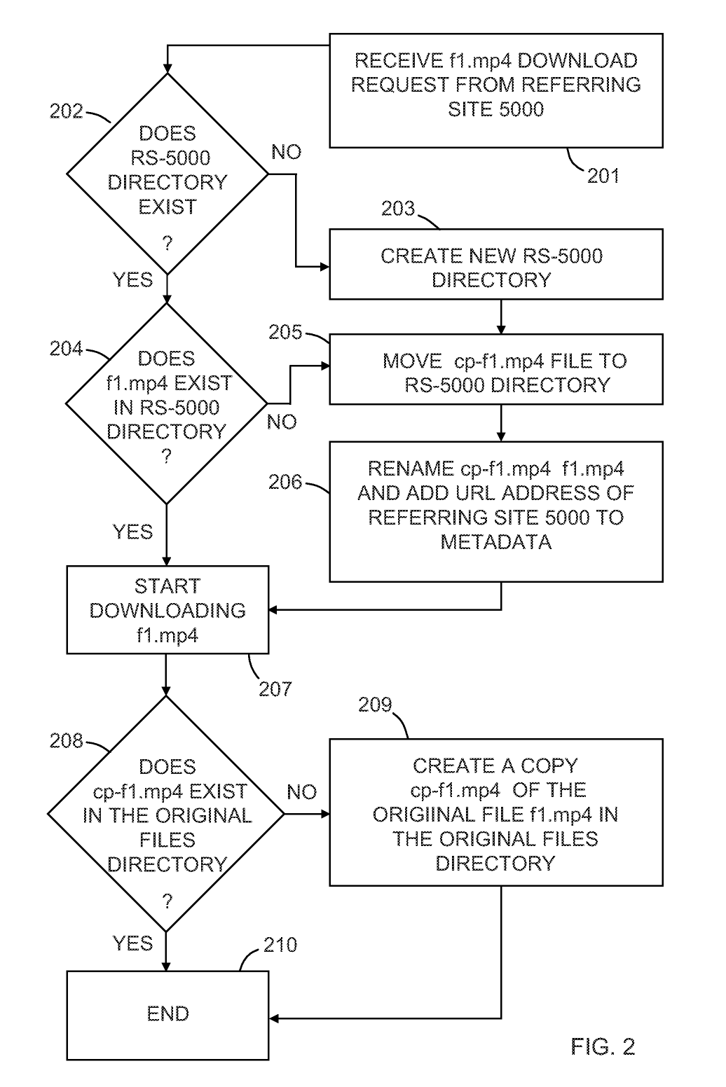

A process of executing a download management application 40 in one implementation is illustrated in further detail in FIG. 2. According to the previously explained example, a user has accessed the referring site 9 number 5,000 and has actuated the link 100 to download the file 1. As a result, the download management application 40 in the download sites 4 receives 201 a download request to download the file 1, as previously explained, and checks 202 if there is in a hard drive of the download sites 4 a directory attributed to referring site 9 number 5,000. If there is not, it creates 203 the directory, which for example is called RS-5000 and which is associated to the URL address http://www.download-site.com/referring-site-5000. If there is, it checks 204 if the directory contains the file 1, which in this example is called f1.mp4. If the directory does not contain the file, or if the directory has just been created 203, it moves 205 to the directory RS-5000 one of the copies of the original file 1 which is stored in an original file directory containing the files delivered by the intermediary site 2. The copy of the original file 1 is called, for example, cp-f1.mp4. Then 206 it renames the file cp-f1.mp4, attributing it the same name as the original file f1.mp4 and copies in the URL9 label of the metadata of the file f1.mp4 the URL address of the referring site 9. As previously explained, the URL address of the referring site 9 was previously received by the download management application 40 as a parameter of the URL address contained in the link which was activated in the referring site 9. Once this information has been copied in the URL9 label of the metadata of file f1.mp4, downloading the file in the computer of the user begins 207. The download management application 40 then checks 208 if there are reserve copies of the original file 1, i.e. it checks if in the original file directory there is any file called cp-f1.mp4. If there is not, it creates 209 one or several copies cp-f1.mp4of the original file f1.mp4 in the original file directory. If the copy of the file already existed, or after having created it, the algorithm ends 210.

Returning to FIG. 1, once the user has downloaded the files 1, the files can be used in a user's computer 5, specifically in an application which is an audiovisual player 52.

In some implementations the intermediary site 2 has a user registration system 26 comprising a Web interface so that users can register and give their personal data and other data suitable for selecting the advertising, such as for example their sex (male, female) their age or their hobbies. During this registration process, the user may choose an access code, such as for example his e-mail address and a password. The user can thus access his data stored in the intermediary site 2 and modify it. The intermediary site 2 can benefit registered users, for example allowing them to play the higher quality or novel contents only for registered users or by sending them less advertising than to non-registered users. When a user registers from the Internet browser 50 of a computer 5 connected 152 to the intermediary site 2, the intermediary site sends to the user's computer 5 a cookie-type file or the like 25 which allows automatically identifying the user without the user having to introduce his access code and password every time the computer 5 communicates with the intermediary site 2. As a person skilled in the art knows, a cookie is a fragment of information which is stored in the hard drive of the visitor of a webpage through his browser, upon request of the webpage server, and which can be retrieved by the server in subsequent visits to the page.

In some implementations the intermediary site 2 makes a selection of the most suitable advertisements for each audiovisual content. To that end, i some implementations the intermediary site 2 has an on-line advertisement auction management module 28, in which the different advertiser sites 8 can offer different prices for their advertisements for certain audiovisual content categories, for example black and white movies, or for a specific audiovisual content, for example the movie “Casablanca”.

The advertisements which have been selected by the intermediary site 2 can be inserted in the files 1 by the actual intermediary site 2 before sending the files to the download site 4, and they can also be inserted by the download site 4. In FIG. 1, the advertisements which are inserted by the intermediary site 2 have reference 22, whereas those which are inserted by the download site 4 have reference 23. In the event that the advertisements 23 are inserted by the download site 4, the intermediary site 2 transmits to the download site 4 a file containing the advertisements 23. This transmission of advertisements 23 from the intermediary site 2 to the download site 4 can be done every so often, for example every hour, every day, every week, etc. This allows the intermediary site 2 to periodically update the advertising which is to be advertised for each file 1. The intermediary site 2 can alternatively send to the download site 4 new complete files 1 containing the new advertisements, even though this solution involves greater bandwidth consumption.

In some implementations the users' equipment 5 are equipped with an audiovisual player 52 and an advertising management system 53, according to the invention, which cooperates with the player 52. The system 53 according to the invention takes care of the fact that the advertisements which are associated to playing the audiovisual content contained in the files 1 are shown. The system 53 allows the user to see the audiovisual content of the files 1 by means of the audiovisual player 52 only if the advertisements which were provided have been shown. As will be seen below, the advertisements can be shown in the form of videos taking up all or part of the screen 54 of the audiovisual player 52, or in the form of text or images which are superimposed on the audiovisual content, or even in the form of audio or in other forms.

FIG. 1 shows a solution in which the system 53 forms part of the audiovisual player 52. However, other solutions are possible: the system 53 can be, for example, an application which is executed in the operative system 51 of the computer 5 and which does not form part of the audiovisual player 52; it can also be an integral part of the actual operative system 51 or it can even be an external apparatus connected to the computer 5.

Another function of the system 53, in addition to allowing the audiovisual content of the files 1 to be played only if the associated advertisements which were provided have been shown, is to communicate to the intermediary site 2 the necessary information so that the intermediary site can bill the advertiser sites 8 for the advertisements which were actually shown in the users' players 52. Based on this billing, the intermediary site 2 can correspondingly remunerate the proprietary content sites 3 for playing the audiovisual content taking place in each audiovisual player 52.

To that end, in some implementations the system 53 communicates on-line 152 with the intermediary site 2 and sends it play information data 27 which allow identifying which advertisements associated to the audiovisual content have been shown together with the playing of such content. The play information data 27 can simply contain the identifier 16 which had been added to the file 1 by the intermediary site 2 before the download. In this case, when the intermediary site 2 receives from the system 53 the identifier 16 of the file 1 it knows, because it has stored this information in its database 21, which of the advertisements were comprised in the file 1 and associated to the audiovisual content of the file and, therefore, which ones have been shown in the audiovisual player 52. The play information data 27 preferably contains data individually identifying each advertisement and which have been introduced in the file 1 in the form of, for example, metadata by the intermediary site 2 or by the download site 4, together with the advertisements 22, 23. Therefore, the system 53 individually informs the intermediary site 2 of each advertisement 22, 23 that has been shown.

Furthermore, in some implementations the system 53 also communicates to the intermediary site 2 the download identifying data 14, 19 which had been included in the file 1 in the form of, for example, metadata before downloading the file 1, by the intermediary site 2 or by the download site 4. The system 53 obtains this downloaded identifying data 14, 19 by simply reading them in the file 1. As previously explained, in some implementations, only the data 19 (identifying data of the referring site 9) and not data 14 (identifying data of the download site 4) are included in the file 1 as download identifying data; in this case the system 53 may only communicate data 19 to the intermediary site 2. However, in some implementations, as shown in FIG. 1 the download identifying data which are inserted in the file 1 and then communicated to the intermediary site 2 by the system 53 are data 14 and data 19.

This download identifying data 14, 19 allows the intermediary site 2 to remunerate the referring sites 9 and the download sites 4 for the participation of the latter in downloading the file 1 which has led to the audiovisual content of the file being played and to the advertisements associated thereto being shown. The advantage of this system is that the referring sites 9 and the download sites 4 will only remunerate the downloads which have actually led to the audiovisual content of the files 1 being played and to the advertisements associated thereto being shown. It can be provided that the intermediary site 2 remunerates the download sites 4 and the referring sites 9 only the first time the audiovisual content of the files 1 downloaded in a player 52 is played, or that it remunerates them on the number of times the audiovisual content is played in each player 52.

Preferably, in the moment in which the user requests playing the audiovisual content of a file 1 in the player 52, the system 53 communicates 152 with the intermediary site 2 to update the advertisements associated to the audiovisual content which must be shown together with the playing of such content. To that end, the system 53 communicates 152 with the intermediary site 2 and transmits it updating data 17 including at least information which allows identifying the audiovisual content of the file 1. This information can be, for example, the mentioned identifier 16 of the file 1. The intermediary site 2 thus identifies the audiovisual content which is going to be played in the player 52 and decides if the advertisements 22 or 23 which were incorporated in the file 1 are suitable and if it is necessary to download other advertisements. This decision is made by the application 20 of the intermediary site 2 taking different factors into account. The factors which the application 20 particularly takes into account are the following:
If the campaigns of the advertiser sites 8 which had provided the advertisements 22 or 23 incorporated to the downloaded file 1 are still active.
If there are new advertiser sites 8 willing to pay a higher price for advertisements associated to the audiovisual content of the file 1. As previously mentioned, in some implementations the intermediary site 2 has an on-line advertisement auction management module in which the different advertiser sites 8 can offer different prices for their advertisements.

The update data 17 also preferably contains unique identifying data of the equipment 5 in which the audiovisual content is going to be played and/or of the user of the computer 5. This unique identifying data can be based, for example, on the serial number of the hard drive of the computer 5, the MAC (Media Access Control Address) address of the network card of the computer 5, the cookie 25 stored in the computer 5, or on any other data which allows identifying the computer 5 and/or the user of the computer 5. Thanks to this unique identifying data, the intermediary site 2 stores in its database 21 the information of the different audiovisual contents that the user downloads and plays in the audiovisual player 52. This information stored in the database 21 allows the intermediary site 2 to create a profile for each user, both for registered users in the intermediary site 2 and for non-registered users. The intermediary site 2 can use this user information or user profile to send the most suitable advertising to each user. Therefore, as a result of the intermediary site 2 receiving the unique identifying data of the computer 5, in order to update the advertisements which will be shown when playing the audiovisual content of a file 1, the application 20 of the intermediary site 2 can take into account several factors relating to the computer 5, in addition to the previously mentioned factors. For example, the application 20 can take the following factors into account:
The available bandwidth of the user in that moment to download new advertisements to the computer 5 from the intermediary site 2. This information can be provided by the system 53, comprised in the update data 17.
The time elapsed from when the user downloaded the file 1. This information can also be provided by the system 53, comprised in the update data 17.

If the application 20 of the intermediary site 2 decides that it is necessary to incorporate new advertisements 24 so that they are shown when playing the audiovisual content of a file 1, it transmits these advertisements 24 on-line to the system 53. It can also transmit in the file containing the advertisements 24 metadata identifying them.

The application 20 of the intermediary site 2 can decide that some of the advertisements 22, 23 which were incorporated in the file 1 must be cancelled, i.e. they should not be shown when playing the audiovisual content of the file 1. The application 20 communicates this decision to the system 53 so that it takes this into account when playing the audiovisual content of the file 1.

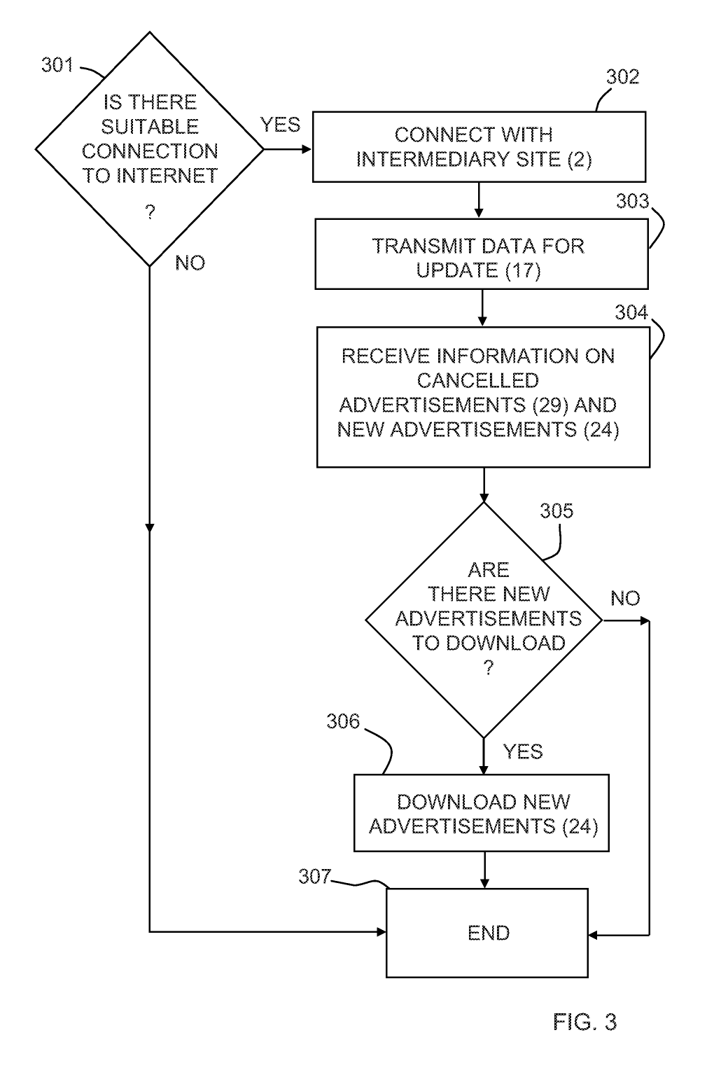

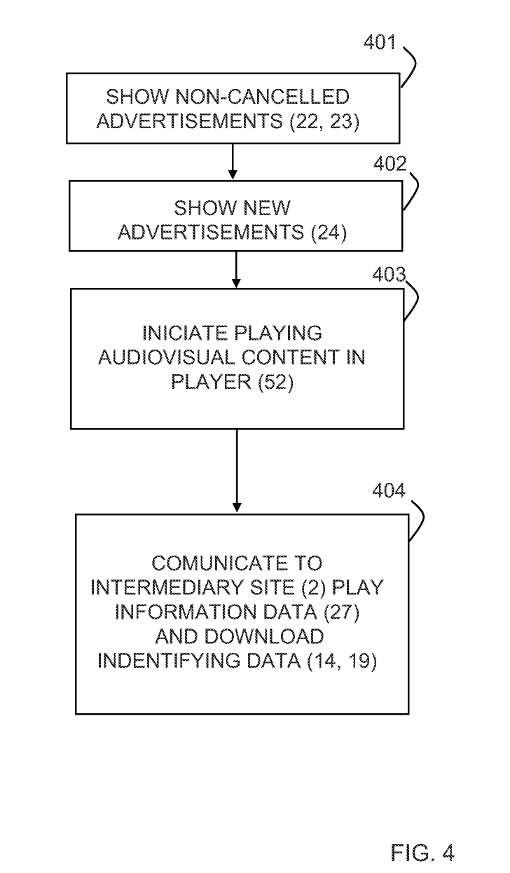

Exemplary processes executed in the system 53 for updating the advertisements and playing them in the player 52 are described below with the aid of FIGS. 3 and 4.

FIG. 3 shows a process executed by the system 53 for the intermediary site 2 to update the advertisements which must be shown. This process is executed when a user using the player 52 of the computer 5 commands it to play the audiovisual content of a file 1. First 301 the system 53 checks if the computer 5 has a connection to Internet that is suitable for downloading new advertisements from the intermediary site 2. If it does not, for example because the user has disconnected the connection to Internet after having downloaded the files 1 or because the available bandwidth is very low and would not allow downloading new advertisements 24, the process ends 307 and the system 53 then executes the process of playing the audiovisual content such as that shown in FIG. 4, which will be described below. In this case only the advertisements 22, 23 which were included in the file 1 will be shown. If it does, i.e. if the connection to Internet is suitable, the system 53 connects 302 with the intermediary site 2 and transmits to it the update data 17. As previously explained, based on this data 17 the application 20 of the intermediary site 2 decides if any of the advertisements 22, 23 which were included in the file 1 must be cancelled and if any new advertisement 24 must be included. The system 53 receives 304 from the intermediary site 2 information 29 on cancelled advertisements and on new advertisements, indicating if any of the advertisements 22, 23 must be cancelled and if it is necessary to download new advertisements 24. If there are new advertisements to be downloaded, 305 the system 53 downloads 306 the advertisements 24 after which the process ends 307. If not, the process directly ends without having attempted to download any new advertisement.

Once this process has ended, in some implementations the system 53 executes the process of FIG. 4 in order to show the advertisements and to play the audiovisual content of the file 1 using the player 52. First 401 the advertisements 22, 23 which were originally included in the file 1 and which have not been cancelled are shown in the player 52. Then 402 the new advertisements 24 which have been downloaded by the system 53 are shown in the player 52. In some implementations playing 403 the audiovisual content of the file 1 in the player 52 only begins if all the advertisements 22, 23 that have not been cancelled and all the new advertisements 24 which have been downloaded are shown. It can optionally be provided that the system 53 allows starting to play the audiovisual content without having shown all the advertisements, and showing the remaining advertisements during the playing or when such playing ends. In some implementations the system 53 stores information indicating which advertisements have been fully shown and communicates 404 to the intermediary site 2 the play information data 27, including an identification of the advertisements which have been shown, and the download data 14, 19 identifying the download sites 4 and the referring sites 9 which have participated in the process which led to downloading the file 1, as previously explained.

In some implementations the system 53 optionally takes into account the time elapsed from when a user downloaded a file 1 for the purpose of preventing that a process according to the invention generates a rejection by the users when they download new advertisements 24. For example, if a user downloads a file 1 and wishes to immediately play its audiovisual content, the user may become angry if he has to wait for new advertisements to be downloaded to see the content. In contrast, a user who downloads a file 1 and waits, for example, three months to play its content may more readily accept that the system 53 downloads new advertisements 24. To that end, the invention provides that the system 53 authorizes playing the audiovisual content of the file, downloads the new advertisements 24 while the audiovisual content is played and shows these new advertisements 24 once they have been downloaded. Preferably, before starting to play, the system 53 informs the user of the advertisements 22, 23, 24 which must be shown so as to authorize fully playing the audiovisual content, and the user can choose to see the advertisements before or while playing the audiovisual content.

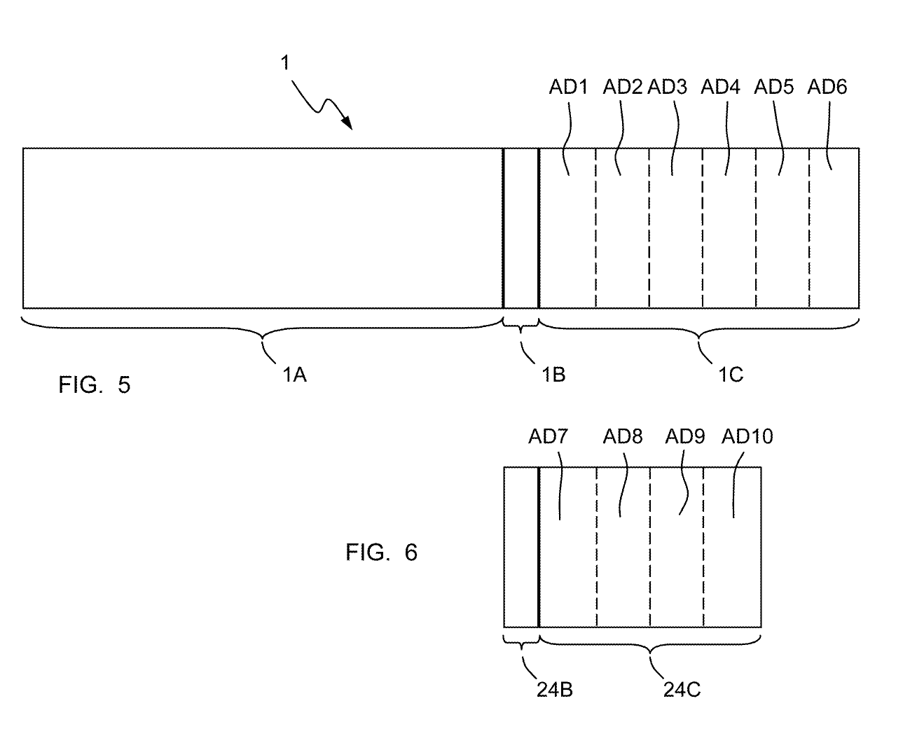

FIG. 5 shows an example of a file 1 with audiovisual content, which is downloaded in a user's computer 5. The file 1 contains a first part 1A with the audiovisual content, a second part 1B with metadata and a third part 1C with six advertisements AD1, AD2, AD3, AD4, ADS and AD6 which have been inserted in the file 1 before it is downloaded in the computer 5. The metadata of the second part 1B contain the unique identifier 16 of the file 1, the identifying data of the advertisements contained in the file 1 and the download identifying data 14, 19. The six advertisements contained in part 1C of the file 1 can be the advertisements 22 (FIG. 1) which have been inserted by the intermediary site 2, or the advertisements 23 (FIG. 1) which have been inserted by the download site 4.

FIG. 6 shows an example of a file containing new advertisements and which is transmitted by the intermediary site 2 to the system 53. This file contains a first part 24B with metadata and a second part 24C containing 4 new advertisements: AD7, AD8, AD9 and AD10. These advertisements are the new advertisements 24 indicated in FIG. 1. The metadata of part 24B contains an indication of the advertisements contained in the file 1 which must be cancelled.

If, for example, the metadata of part 24B of the file of FIG. 6 indicates that advertisements AD2 and ADS must be cancelled, the system 53 will only show advertisements AD1, AD3, AD4, AD6 (advertisements inserted in the file 1 before the download and which have not been cancelled) and advertisements AD7, AD8, AD9 and AD10 (new advertisements delivered by the intermediary site 2).

In the event that there are no new advertisements, part 24C of the file of FIG. 6 is empty and part 24B, in addition to possibly containing an indication of the advertisements of the file 1 which must be cancelled, also contains an indication that there are no new advertisements.

In some implementations, an optional improvement to prevent a user from being absent during the entire time in which the advertisements are shown is provided. This improvement consists of the fact that the system 53 cooperates with the audiovisual player 52 so that when the player has finished showing an advertisement, it waits to receive an indication from the user to begin to broadcast the following advertisement. Therefore, in order to see the audiovisual content, which in some implementations is only played when all the provided advertisements have been shown, the user must be present to indicate to the audiovisual player 52 to show each advertisement. In order for the user to give this indication, it can be provided for example that he pushes the play button of the audiovisual player 52. The system 53 preferably cooperates with the player 52 so that the latter does not show the audiovisual content of the file 1 if the time elapsed between the end of an advertisement and the moment in which the user clicks on the play button of the player 52 so that it shows the following advertisement exceeds a certain threshold. The user will thus pay attention to the advertisements in order to be able to act when each one of them ends.

In the embodiment described above, the system 53 may form part of the audiovisual player 52, i.e. the audiovisual player 52 is a player according to the invention which incorporates the system 53.

However, the invention also provides that the process according to the invention is compatible with the use of audiovisual players that do not incorporate the system 53, and that they can be audiovisual players according to the prior state of the art. To that end, a mechanism is necessary which allows the downloaded files to be seen in players from the prior state of the art and which guarantees that the users have seen the advertisements associated to the audiovisual content of the downloaded files.

A first solution consists of incorporating the advertisements to the audiovisual content, such that the advertisements are superimposed thereon. Therefore, when an audiovisual player from the state of the art plays the audiovisual content, it will also be playing the superimposed advertisements. For example, the advertisements can take up part of the screen in which the audiovisual content is played, or they can be text or graphic advertisements taking up the lower part of the screen. To that end, the intermediary site 2, the download site 5 and the system 53 are provided with an application which superimposes the advertisements on the audiovisual content. The way of performing such superimposition is within the scope of a person skilled in the art and it is therefore not considered necessary to describe it in further detail.

Another solution consists of the audiovisual content of the downloaded files being protected such that it can only be played if the system 53 authorizes it, and that the system 53 only authorizes playing it if it has been able to check that the user has seen the advertisements. In order to manage this authorization, the system 53 can use several methods, such as for example encrypting the content or using DRM technologies. A solution consists of the system 53 sending a message to the intermediary site 2 indicating that the advertisements have been shown in the computer 5, together with an identifier of the hardware of the computer 5, such as for example the serial number of the hard drive, and the intermediary site 2 sending back to the system 53 a message containing a key which allows the use of the content of the file but only in the computer 5. These types of protections or DRM technologies are widely known by a person skilled in the art.

Different techniques can be used in order for the system 53 to be able to check if the advertisements have been shown.

A first technique consists of the system 53 communicating with the audiovisual player in order to know the content that is being played. Some audiovisual players have specific development tools, such as for example the SDK (Software Development Kit) by Microsoft Media Player, which can be programmed to implement this communication. Another technique which can be used by the system 53 for performing the check consists of applying the technologies referred to as watermarking and perceptual hashing. Watermarking technology consists of adding to the audiovisual content marks that cannot be detected by the user, referred to as watermarks, which are detected when the content is played in an audiovisual player. Perceptual hashing technologies consist of generating a file, referred to as hash, which is different and unique for each audiovisual content played. These technologies are known by the person skilled in the art and it is therefore not considered necessary to explain them in further detail.

If a user does not have the system 53 installed in his computer when he attempts to play the audiovisual content of a downloaded file 1, the audiovisual player shows a message indicating to the user that it is necessary to install the system 53. This message is included in the downloaded file 1 and is the only part of the file 1 that the user can see if he does not install the system 53.

It can be seen that the process according to the invention is compatible with different downloading technologies, such as for example the BitTorrent file transfer protocol. In an embodiment of the invention, instead of directly downloading a complete file 1 from the download site 4, the user can download from the download site 4 a Torrent-type locator file, i.e. a file with a torrent extension containing information which allows locating nodes on the Internet which have already downloaded the file 1 or parts thereof and which can be used as a source for downloading the file 1 in parallel from a plurality of the nodes. In this case, the metadata containing the download identifying data is incorporated as metadata of the Torrent file. The advertising management system 53 can read this metadata in the Torrent file. An alternative advantageous solution consists of a Torrent file download application being executed in the user's computer 5, reading the metadata in the Torrent file and included it as metadata in the file 1 which has been downloaded. This solution has the advantage that it allows doing away with the Torrent file once the download of the file 1 has been completed, whereby it is possible to use standard processes such as those described above, regardless of if the file 1 has been downloaded directly or by means of a locator file.

The processes according to the invention which have been described above with the aid of FIGS. 1 to 6 relate to a variety of ways of managing the advertisements according to which the file 1 which is downloaded in a user's computer 5 has advertisements 22, 23 incorporated therein, and in some implementations an advertising management system 53 sees to it that it is impossible to play the audiovisual content of the file 1 if the advertisements 22, 23 contained in the file 1 or the new advertisements 24 which the system 53 has downloaded from the intermediary site 2 are not shown in the actual audiovisual player 52.

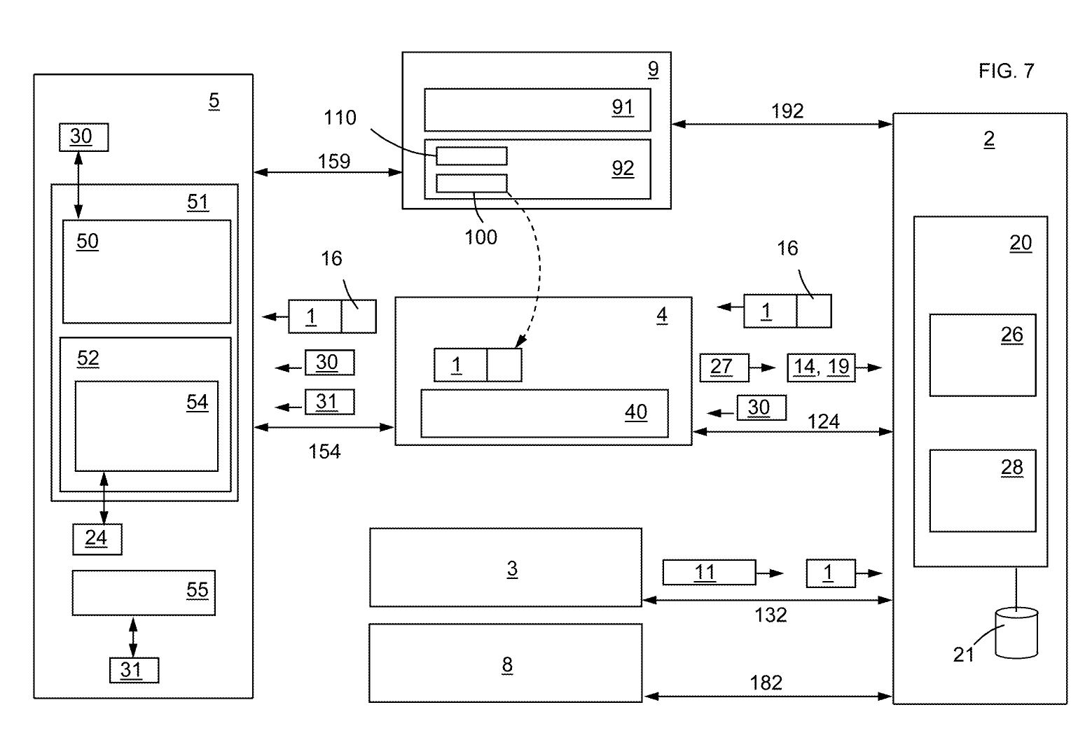

FIG. 7 illustrates an exemplary system useful for implementing other embodiments. Instead of being inserted in the file 1 which is downloaded in a user's computer 5, the advertisements are shown by the browser 50 of the computer 5 when it connects to the download site 4 to download the file 1. The download site 4 does not authorize downloading the file 1 as long as the advertisements have not been shown through the browser 50 in the computer 5. The processes according to these management forms is described below in further detail in reference to FIG. 7.

The same reference numbers have been used in FIG. 7 as those used in FIG. 1 to refer to the elements which are substantially the same.

The intermediary site 2 does not include the advertisements in the files 1 that it sends to the download site 4, but rather it separately delivers advertisements 30 associated to each file 1. When a user downloads one of these files 1 in the computer 5 using the browser 50 which is connected to the download site 4, the browser 50 shows the advertisements 30 associated to the file 1 and does not start to download the file 1 until the advertisements 30 have been shown in the browser 50. The advertisements 30 are preferably shown in the browser 50 using a streaming-type display technology, i.e. they are played in the screen of the computer 5 at the same time they are downloaded from the download site 4. Streaming-type display technologies are known by the person skilled in the art; they are implemented, for example, by applying the RTSP (Real Time Streaming Protocol) protocol. The advantage of using streaming-type technology is that the download site 4 knows when the advertisements 30 have been shown in the browser 50 of the computer 5 and only then will it allow the downloading of the file 1 to begin.

To prevent a user from being absent while the advertisements are shown in the browser 50, or canceling the effective display of the advertisements, for example by reducing the window of the browser 50, in some implementations the invention provides an improvement which consists of when the showing of an advertisement has ended, the user must interact with the computer 5 so that it begins to show the following advertisement. This can be done, for example, by making each advertisement a different streaming session and by making the user click on the play button of the player of the browser 50 so that each streaming session, i.e. so that the showing of each advertisement begins. The download site 4 preferably does not authorize downloading the digital file 1 if the time elapsed between the end of a streaming session and the moment in which the user clicks on the play button to indicate that it begin the following streaming session exceeds a certain threshold. The user will thus pay attention to the advertisements in order to be able to act when each one of them ends.

Once the advertisements 30 have been shown in the browser 50 and the file 1 has subsequently been downloaded in the computer 5, the download site 4 sends the download identifying data 14, 19 to the intermediary site 2, identifying the referring site 9 and the download site 4 which have contributed to downloading the file 1, and the play information data 27 which allow identifying which advertisements associated to the audiovisual content have been shown. As can be seen, in this case the data 27 and 14, 19 is sent to the intermediary site 2 by the download site 4, and not by the system 53 of the computer 5 as occurred in the process according to FIG. 1. It is therefore not necessary for the computer 5 to be equipped with a system 53 with these functionalities.

In order to prevent that the file 1 can be freely played after having been downloaded, the number of times the audiovisual content of the file 1 can be played and/or the time during which the audiovisual content can be played since the advertisements 30 were shown is limited. Furthermore, playing the audiovisual content of the file 1 is preferably only allowed in the computer 5 in which the advertisements 30 have been seen. To that end, a digital rights management or DRM system, which can be an application 55 installed in the computer 5, is used. The application 55 checks that in the computer in which the audiovisual content of the file 1 is going to be played there is a witness file which certifies that the advertisements 30 have been shown in the computer. This witness file can be for example a cookie 31 which has been transmitted to the computer 5 from the download site 4 or from the intermediary site 2 after the advertisements 30 have been shown. The application 55 will only allow playing the audiovisual content of the file 1 if it checks the existence of the witness file 31 in the computer 5. In the example shown in FIG. 7, the download site 4 sends the cookie 31 to the computer 5 when the display of the advertisements 30 by means of streaming in the browser 50 has ended.

In the example shown in FIG. 7, the application 55 is installed in the computer 5 and does not form part of the player 52. However, the invention also provides that the application 55 is integrated in the player 52 or in the browser 50. The application 55 can be, for example, a plugin for the browser 50.

In some implementations the download site 4 can choose between the various advertisement management forms, such as those described above in reference to FIGS. 1 and 7, depending on whether or not the computer 5 downloading the files 1 is provided with an advertising management system 53. If the computer 53 is provided with a system 53, the download site chooses the first advertisement management form according to FIG. 1, and in the event that it is not, it chooses the second way according to FIG. 7.

The advertising management system 53 (in the first advertisement management form according to FIG. 1) or the digital rights management application 55 (in the second advertisement management form according to FIG. 7) sees to it that a user cannot see the audiovisual content of the file 1 in another computer different from the computer 5 in which the file 1 has been downloaded if the user does not see the advertisements associated to the audiovisual content.

In order to choose between these two advertisement management forms, it is necessary for the download site 4 to know whether or not the computer 53 is provided with a system 53. To that end, the system 53 causes the creation of a cookie which is stored in the computer 5 and transmitted to the download site 4 when the computer 5 connects to the site download 4 to download a file 1. When the download site 4 receives a download petition to download a file 1 from the browser 50 of the computer 5, the cookie that was stored in the computer 5 is transmitted to the download site 4 and the site then knows that there is a system 53 installed in the computer 5 and chooses the first advertisement management form (FIG. 1). If the download site does not receive the cookie, it deduces that the computer 5 is not equipped with a system 53 and chooses the second advertisement management form (FIG. 7).

Cookies are created by Web servers and not by a computer application such as the system 53. In order for the system 53 to cause the creation of the cookie, the invention provides that the download site 4 has a webpage the purpose of which is to create the cookie, and that the system 53 accesses the webpage using the browser 50 of the computer 5. The system 53 does not create the cookie, rather it uses the browser 50 to access the webpage of the download site 4 which is who creates the cookie and sends it to the computer 5. The URL address of the webpage of the download site 4 forms part of the identifying data 14 of the download site 4 which is incorporated in the file 1.

As the person skilled in the art will easily understand, even though the embodiments herein described relate to a computer, websites and webpages operating on the Internet, the invention can also be applied to other communications systems, such as for example a system acting in a communications network for cellular telephones or other similar devices. In this case, instead of a computer, the users use a cellular telephone to download and play the files with audiovisual content, and the different sites (intermediary site, referring sites, download sites, proprietary content sites and advertiser sites) operate in the communications network for cellular telephones.

What is claimed is:

1. A computer-implemented method comprising:
establishing communication with a computing device, the communication having been established by use of a link on a referring site, the link associated with a digital file,
receiving from the referring site information that identifies the referring site,
transmitting at least a portion of the digital file and one or more associated advertisements to the computing device upon receiving a request originating from the computing device to download all or a portion of the digital file to the computing device,
detecting if the one or more advertisements have been played in the computing device; and
maintaining first data useable to remunerate the referring site upon detecting that the one or more advertisements have been played in the computing device.

2. A method according to claim 1, wherein the process of transmitting at least a portion of the digital file and the one or more associated advertisements to the computing device comprises creating an updated digital file by combining the one or more advertisements with at least a portion of the digital file and transmitting the updated digital file to the computing device.

3. A method according to claim 1, wherein the one or more advertisements are obtained from one or more advertisers via one or more advertising sites.

4. A method according to claim 3, further comprising maintaining second data that is at least partially based on detecting if the one or more advertisements have been played in the computing device, the second data useable for determining remuneration from the one or more advertisers.

5. A method according to claim 2, wherein the updated digital file comprises the information that identifies the referring site.

6. A method according to claim 2, wherein the information that identifies the referring site is incorporated in the updated digital file as file properties metadata of the updated digital file.

7. A method according to claim 2, further comprising transmitting to the computing device one or more new advertisements associated with the update digital file after the updated digital file has been transmitted to the computing device.

8. A method according to claim 1, further comprising storing content information about the content of the digital file and automatically selecting the one or more advertisements based at least in part on the content information.

9. A method according to claim 1, wherein the digital file, or a portion thereof, is received from a proprietor via a proprietary site, the method further comprising detecting if the digital file, or a portion thereof, has been implemented in the computing device and maintaining third data at least partially based on detecting if the digital file, or a portion thereof, has been implemented in the computing device, the third data useable for determining remuneration to the proprietor.

10. A method according to claim 1, further comprising receiving from a proprietary site digital file content information and transmitting on-line one or more links to be installed in the referring site, or multiple referral sites, based on the content information.

11. A method according to claim 1, further comprising transmitting an instruction to the computing device to cancel the one or more advertisements.

12. A method according to claim 1, wherein the digital file comprises audiovisual content.

13. A method according to claim 12, wherein the one or more advertisements are combined with the audiovisual content in a manner that facilitates the one or more advertisements to be superimposed on at least a portion of the audiovisual content when the audiovisual content is played in the computing device.

14. A computer-implemented method comprising:
based on file content information associated with a digital file, selecting a referring site and transmitting on-line a link to the referring site,
establishing communication with a computing device by use of the link and receiving information that identifies the referring site,
creating an updated digital file by combining one or more advertisements with at least a portion of a digital file prior to or upon receiving a request originating from the computing device to download all or a portion of the digital file to the computing device,
transmitting the updated digital file to the computing device,
detecting if the one or more advertisements have been played in the computing device; and
maintaining first data useable to remunerate the referring site upon detecting that the one or more advertisements have been played in the computing device.

15. A method according to claim 14, wherein the one or more advertisements are obtained from one or more advertisers via one or more advertising sites, the method further comprising maintaining second data that is at least partially based on detecting if the one or more advertisements have been played in the computing device, the second data useable for determining remuneration from the one or more advertisers.

16. A method according to claim 14, wherein the updated digital file comprises the information that identifies the referring site.

17. A method according to claim 14, wherein the information that identifies the referring site is incorporated in the updated digital file as file properties metadata of the updated digital file.

18. A method according to claim 14, wherein the one or more advertisements are selected to be combined with the digital file by use of the file content information.

19. A method according to claim 14, wherein the digital file, or a portion thereof, is received from a proprietor via a proprietary site, the method further comprising detecting if the digital file, or a portion thereof, has been executed in the computing device and maintaining third data at least partially based on detecting if the digital file, or a portion thereof, has been executed in the computing device, the third data useable for determining remuneration to the proprietor.

20. A method according to claim 14, wherein the digital file comprises audiovisual content.

21. A method according to claim 20, wherein the one or more advertisements are combined with the audiovisual content in a manner that facilitates the one or more advertisements to be superimposed on at least a portion of the audiovisual content when the audio visual content is played in the computing device.

22. A computer-implemented method comprising:
based on file content information associated with a digital file, selecting a referring site and transmitting on-line a link to the referring site that facilitates establishing communication between a computing device and a download site by use of the link,
receiving from the download site first information that identifies the referring site and the digital file,
based on the file content information, facilitating the transmission of one or more advertisements to the download site so that the one or more advertisements may be combined with at least a portion of the digital file,
receiving second information indicative of the one or more advertisements having been played in the computing device; and
maintaining first data useable to remunerate the referring site upon receiving the information indicative of the one or more advertisements having been played in the computing device.

23. A method according to claim 22, wherein the second information is received from the download site.

24. A method according to claim 22, wherein the second information is received from the computing device.

25. A method according to claim 22, wherein the step of facilitating the transmission of one or more advertisements to the download site comprises directly transmitting the one or more advertisements to the download site.

26. A method according to claim 22, wherein the digital file comprises audiovisual content.

27. A computer-implemented method comprising:
receiving in a first site a digital file,
establishing communication between the first site and a computing device, the communication having been established by use of a link on a referring site that requests a download of the digital file to the computing device,
receiving in the first site from the referring site information that identifies the referring site and information that identifies the digital file,
receiving in the first site from a second site one or more advertisements,
creating in the first site an updated digital file by combining the one or more advertisements with at least a portion of the digital file, the updated digital file comprising the information that identifies the referring site and information that identifies the second site,
transmitting at least a portion of the updated digital file from the first site to the computing device,
receiving in the second site from the computing device information indicative that the one or more advertisements have been played in the computing device and the information that identifies the referring site; and
maintaining first data in the second site useable to remunerate the referring site upon receiving the information indicative that the one or more advertisements have been played in the computing device.

28. A method according to claim 27, wherein the second site receives the one or more advertisements from one or more advertisers via one or more advertising sites.

29. A method according to claim 28, further comprising maintaining second data in the second site upon receiving the information indicative that the one or more advertisements have been played in the computing device, the second data useable for determining remuneration from the one or more advertisers.

30. A method according to claim 27, wherein the information that identifies the referring site is incorporated in the updated digital file as file properties metadata of the updated digital file.

31. A method according to claim 27, further comprising storing content information about the content of the digital file in the second site, receiving in the second site from the first site information associating the digital file with the content information, and automatically selecting in the second site the one or more advertisements based at least in part on the content information.

32. A method according to claim 27, wherein the digital file is received from a proprietor via a proprietary site, the updated digital file comprising information that identifies the proprietor, the method further comprising receiving in the second site from the computing device the information that identifies the digital file and information that identifies the proprietor after the updated digital file is executed in the computing device, the second site maintaining third data useable for determining remuneration to the proprietor.

33. A method according to claim 27, wherein the digital file comprises audiovisual content.

34. A method according to claim 33, wherein the one or more advertisements are combined with the audiovisual content in a manner that facilitates the one or more advertisements to be superimposed on at least a portion of the audiovisual content when the audiovisual content is played in the computing device.
